(19) United States
(12) Patent Application Publication
(10) Pub. No.: US 2025/0086550 A1
(43) Pub. Date: Mar. 13, 2025

(54) ENTERPRISE CYBER SECURITY OFFICE SERVER SYSTEM AND METHOD

(71) Applicants: Chandra Bhat, Rocky Hill, CT (US); Joshua D. Cohen, West Hartford, CT (US)

(72) Inventors: Chandra Bhat, Rocky Hill, CT (US); Joshua D. Cohen, West Hartford, CT (US)

(21) Appl. No.: 18/465,600

(22) Filed: Sep. 12, 2023

(51) Int. Cl. G06Q 10/0635

(52) U.S. Cl. CPC G06Q 10/0635

(57) ABSTRACT

An enterprise cyber security back-end application computer server may receive a Chief Information Security Office (“CISO”) request. Responsive to the CISO request, the computer server may automatically create an enterprise application reference implementation. Based on CISO parameters in a CISO data store, the computer server may automatically transmit information about the reference implementation to a communication address associated with a CISO party. Similarly, based on Chief Information Office (“CIO”) parameters in a CIO data store, the computer server may automatically transmit information about the reference implementation to a communication address associated with a CIO party. Data may then be exchanged with a remote device via a distributed communication network to support interactive user interface displays that include information about the reference implementation.

### TECHNICAL FIELD

The present application generally relates to computer systems and more particularly to computer systems that are adapted to accurately, securely, and/or automatically perform cyber security functions for an enterprise.

### BACKGROUND

An enterprise, such as a business, may rely on many different computer applications and an Information Technology (“IT”) infrastructure. For example, applications may handle customer interactions, financial accounting and projections, communications and workflows between employees of the enterprise, Human Resources (“HR”) and payroll tasks, etc. Moreover, the computer application and IT infrastructure may be vulnerable to cyber security breaches such as “cyber threats.” As used herein, the phrase “cyber threat” may refer to, for example, any potential negative action or event facilitated by a vulnerability that results in an unwanted impact to a computer system or application of an enterprise. Examples of threats include hacking by an individual or criminal organization. Threats may be associated various circumstances and events that adversely impact organizational operations (e.g., an enterprise mission, function, image, reputation), organizational assets, or individuals through an information system via unauthorized access, destruction, disclosure, modification of information, denial of service, etc.

An enterprise may be organized in a way to help improve computer security and manage IT resources. For example, FIG. 1 shows a typical enterprise configuration 100 associated with cyber security. A Chief Information Security Office (“CISO”) 110, may be responsible for establishing and maintaining the enterprise vision, strategy, and program to ensure that information assets and technologies are adequately protected. The CISO 110 may identify, develop, implement, and/or maintain processes across the enterprise to reduce information and IT risks. The CISO 110 may respond to incidents, establish appropriate standards and controls, manage security technologies, direct the establishment and implementation of policies and procedures, etc.

A Chief Information Office (“CIO”) 120 may provide an interface between the business needs, user needs, and the information and communication technology used in the enterprise. The CIO 120 may also play a role in helping to control costs and increase profits via the use of IT.

When the CISO 110 defines a security priority and/or policy, it is generally provided to the CIO 120 as a reverse demand (“we need you to update the following application components”). Such an approach gives the CIO 120 only a limited amount of time to plan and/or budget the changes associated with the request. Moreover, application teams might not have all of the background knowledge about a particular security initiative, which may result in a delayed response and/or reaction to the CISO 110 request. This can make a manual response to a CISO request a time-consuming, costly, and error-prone task-especially when a CIO 120 responsible for thousands of different applications with the enterprise.

It would be desirable to provide improved systems and methods to accurately and/or automatically provide cyber security functions and/or office tools for an enterprise. Moreover, the results should be easy to access, understand, interpret, update, etc.

### SUMMARY OF THE INVENTION

According to some embodiments, systems, methods, apparatus, computer program code and means are provided to accurately and/or automatically provide enterprise cyber security office tools for an enterprise in a way that provides fast, secure, and useful results and that allows for flexibility and effectiveness when responding to those results.

Some embodiments are directed to an enterprise cyber security system implemented via a back-end application computer server. The computer server may receive a CISO request and, responsive to the CISO request, automatically create an enterprise application reference implementation. Based on CISO parameters in a CISO data store, the computer server may automatically transmit information about the reference implementation to a communication address associated with a CISO party. Similarly, based on CIO parameters in a CIO data store, the computer server may automatically transmit information about the reference implementation to a communication address associated with a CIO party. Data may then be exchanged with a remote device via a distributed communication network to support interactive user interface displays that include information about the reference implementation.

Some embodiments comprise: means for receiving, at a back-end application computer server, a CISO request; responsive to the CISO request, means for automatically creating an enterprise application reference implementation; based on CISO parameters in a CISO data store, means for automatically transmitting information about the reference implementation to a communication address associated with a CISO party, wherein the CISO data store contains electronic records associated with a plurality of CISO party identifiers, and, for each CISO party identifier, a communication address and at least one CISO parameter; based on CIO parameters in a CIO data store, automatically transmitting information about the reference implementation to a communication address associated with a CIO party, wherein the CIO data store contains electronic records associated with a plurality of CIO party identifiers, and, for each CIO party identifier, a communication address and at least one CIO parameter; and means for exchanging data with a remote device via a distributed communication network to support interactive user interface displays that include information about the reference implementation.

In some embodiments, a communication device associated with a back-end application computer server exchanges information with remote devices in connection with interactive graphical user interfaces. The information may be exchanged, for example, via public and/or proprietary communication networks.

A technical effect of some embodiments of the invention is improved and computerized enterprise cyber security for an enterprise that provides fast, secure, and useful results. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 shows a typical enterprise configuration associated with cyber security.

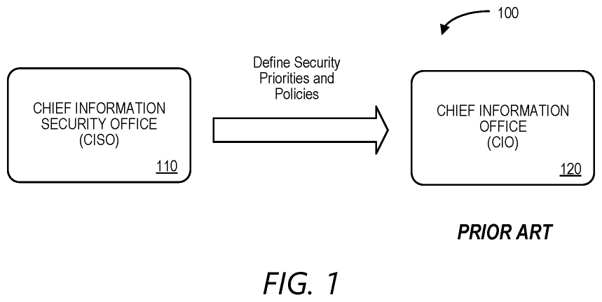

FIG. 2 is an enterprise configuration according to some embodiments.

FIG. 3 is a high-level block diagram of an enterprise cyber security system in accordance with some embodiments.

FIG. 4 illustrates a high-level enterprise cyber security method according to some embodiments.

FIG. 5 is an enterprise cyber focal office display in accordance with some embodiments.

FIG. 6 illustrates cyber focal office interactions according to some embodiments.

FIG. 7 is a tablet computer providing a cyber focal optimize display in accordance with some embodiments.

FIG. 8 is a cyber focal advance display according to some embodiments.

FIG. 9 is a smartphone providing a cyber focal response display in accordance with some embodiments.

FIG. 10 is a cyber focal office team function method according to some embodiments.

FIG. 11 is a cyber focal office responsibilities method in accordance with some embodiments.

FIG. 12 is a cyber focal office information method according to some embodiments.

FIG. 13 is a more detailed system according to some embodiments.

FIG. 14 is a block diagram of an apparatus in accordance with some embodiments.

FIG. 15 is a portion of a tabular security request database according to some embodiments.

FIG. 16 is an operator or administrator display in accordance with some embodiments.

FIG. 17 illustrates a system having a predictive model in accordance with some embodiments.

### DETAILED DESCRIPTION

Before the various exemplary embodiments are described in further detail, it is to be understood that the present invention is not limited to the particular embodiments described. It is also to be understood that the terminology used herein is for the purpose of describing particular embodiments only and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

The present invention provides significant technical improvements to facilitate data processing associated with enterprise cyber security. The present invention is directed to more than merely a computer implementation of a routine or conventional activity previously known in the industry as it provides a specific advancement in the area of electronic record analysis by providing improvements in the operation of a computer system that customizes enterprise cyber security (including those associated with risk relationships). The present invention provides improvement beyond a mere generic computer implementation as it involves the novel ordered combination of system elements and processes to provide improvements in the speed, security, and accuracy of such an enterprise cyber security tool for an enterprise. Some embodiments of the present invention are directed to a system adapted to automatically customize and execute enterprise cyber security, aggregate data from multiple data sources, automatically optimize cyber security information to reduce unnecessary messages or communications, etc. (e.g., to consolidate security priorities and policies). Moreover, communication links and messages may be automatically established, aggregated, formatted, modified, removed, exchanged, etc. to improve network performance (e.g., by reducing an amount of network messaging bandwidth and/or storage required to create enterprise cyber security messages or alerts, improve security, reduce the size of a chief information security office data store, more efficiently collect cyber security hazard data, etc.).

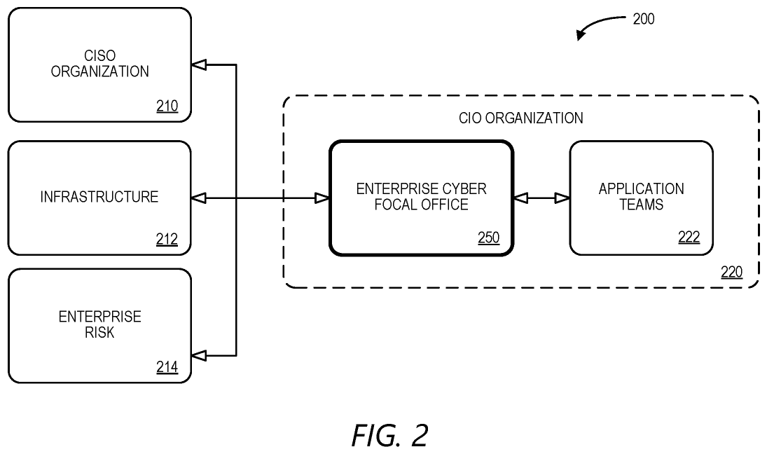

FIG. 2 is an enterprise configuration 200 according to some embodiments. The configuration 200 includes a CISO organization 210 and a CIO organization 220. The CIO organization 220 includes an enterprise cyber focal office 250. The enterprise cyber focal office 250 may, for example, be designed to serve as a bridge between the CIO and CISO organizations 210, 220 to help bring security strategies and initiatives to application teams 222. The enterprise cyber focal office 250 may also use information about enterprise infrastructure 212 and enterprise risk 214 to respond to request from the CISO organization 210. The enterprise cyber focal office 250 may represent a primary focal point that provides oversight within an organization to ensure that recovery plans are in place, maintained and validated-including vendor provided services. The enterprise cyber focal office 250 may also serve to represent, consult, and provide recommendation about relevant continuity related matters to all stakeholders as well as to advise during critical events or escalate within the organization if needed. This enterprise cyber focal office 250 may have an in-depth understanding of the organization and inform executive leaders about the strategic impact of business continuity risks across functional areas.

According to some embodiments, the enterprise cyber focal office 250 may analyze system/business impacts and triage IT response for applications and communicate with Lines Of Business (“LOB”) within the enterprise and IT leadership. The enterprise cyber focal office 250 may, for example, create and maintain cyber response guidebook updates/responses and lead planning and execution of application, alerting, and monitoring enhancements within the CIO organization 220. The enterprise cyber focal office 250 may also make prioritization decisions to incorporate application security enhancements and remediation with business roadmaps and document a summary of a recovery experience and lessons learned for an after-action report. According to some embodiments, the enterprise cyber focal office 250 may be engaged in broader crisis response for large scale events and coordinate application remediation and restoration during cyber events that impact application functionality or data.

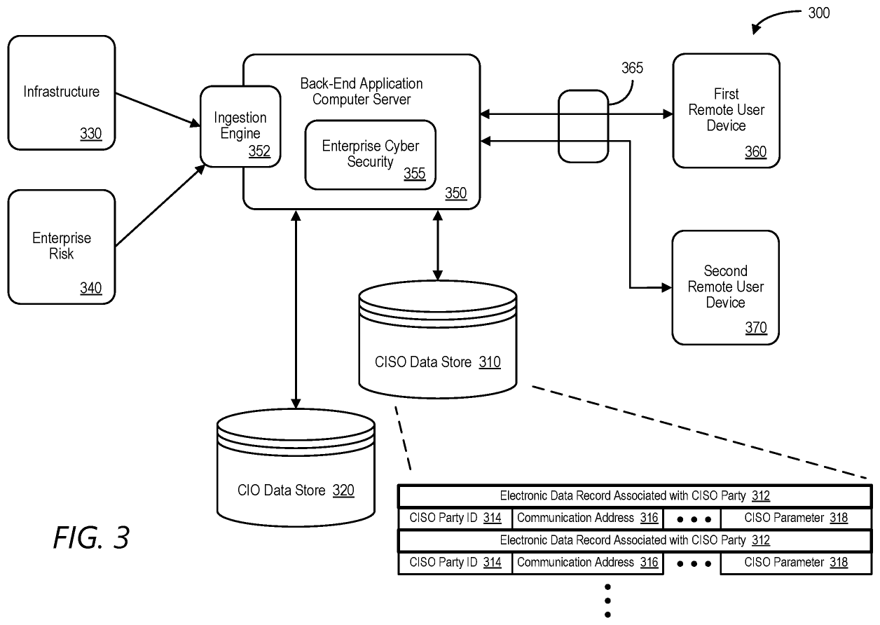

FIG. 3 is a high-level block diagram of an enterprise cyber security system 300 that may be provided according to some embodiments of the present invention. In particular, the system 300 includes a back-end application computer server 350 that may access information in a CISO data store 310 (e.g., storing a set of electronic records associated with various CISO parties 312, each record including, for example, one or more CISO party identifiers 314, communication addresses 316, CISO parameters 318, etc.). The back-end application computer server 350 may also store information into other data stores, such as a CIO data store 320, and utilize an ingestion engine 352 and enterprise cyber security 355 to exchange and process messages (e.g., daily/weekly data sweeps or on-demand changes) and view, analyze, and/or update the electronic records. The back-end application computer server 350 may also exchange information with a first remote user device 360 and a second remote user device 370 (e.g., via a firewall 365). According to some embodiments, an interactive graphical user interface platform of the back-end application computer server 350 may facilitate enterprise cyber security, recommendations, alerts, and/or the display of results via one or more remote administrator computers (e.g., to summarize system 300 performance) and/or the remote user devices 360, 370. For example, the first remote user device 360 may transmit annotated and/or updated information to the back-end application computer server 350. Based on the updated information, the back-end application computer server 350 may adjust data in the CISO data store 310 and/or the CIO data store 320 and the change may (or may not) be used in connection with the second remote user device 370. Note that the back-end application computer server 350 and/or any of the other devices and methods described herein might be associated with a third party, such as a vendor that performs a service for an enterprise. In some cases, the ingestion engine 352 may receive information from about enterprise infrastructure 330 and/or enterprise risk 340.

The back-end application computer server 350 and/or the other elements of the system 300 might be, for example, associated with a Personal Computer (“PC”), laptop computer, smartphone, an enterprise server, a server farm, and/or a database or similar storage devices. According to some embodiments, an “automated” back-end application computer server 350 (and/or other elements of the system 300) may facilitate the automated access and/or update of electronic records in the data stores 310, 320 and/or the management of CISO requests. As used herein, the term “automated” may refer to, for example, actions that can be performed with little (or no) intervention by a human.

Devices, including those associated with the back-end application computer server 350 and any other apparatus described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 350 may store information into and/or retrieve information from the CISO data store 310 and/or the CIO data store 320. The data stores 310, 320 may be locally stored or reside remote from the back-end application computer server 350. As will be described further below, the CISO data store 310 may be used by the back-end application computer server 350 in connection with an interactive user interface to access and update electronic records. Although a single back-end application computer server 350 is shown in FIG. 3, any number of such devices may be included. Moreover, various devices described herein might be combined according to embodiments of the present invention. For example, in some embodiments, the back-end application computer server 350 and CISO data store 310 might be co-located and/or may comprise a single apparatus.

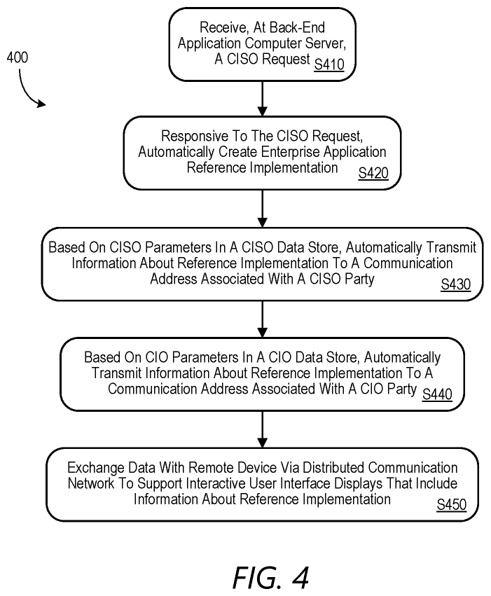

The elements of the system 300 may work together to perform the various embodiments of the present invention. Note that the system 300 of FIG. 3 is provided only as an example, and embodiments may be associated with additional elements or components. According to some embodiments, the elements of the system 300 automatically transmit information associated with an interactive user interface display over a distributed communication network. FIG. 4 illustrates a method 400 that might be performed by some or all of the elements of the system 300 described with respect to FIG. 3, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S410, a computer processor of a back-end application computer server may receive a CISO request. The CISO request might be associated with, for example, a security priority and/or a security policy. At S420, the system automatically creates an enterprise application “reference implementation” responsive to the CISO request. As used herein, the phrase “reference implementation” may refer to a standard “best practices” implementation that can be utilized by many different applications in a CIO organization. According to some embodiments, the back-end application computer server is further to generate the reference implementation based on Chief Technology Office (“CTO”) infrastructure information and/or enterprise risk information.

Based on CISO parameters in a CISO data store, the system automatically transmits information about the reference implementation to a communication address associated with a CISO party at S430. The CISO data store may, for example, contain electronic records associated with a plurality of CISO party identifiers, and, for each CISO party identifier, a communication address and at least one CISO parameter. Similarly, based on CIO parameters in a CIO data store, the system automatically transmits information about the reference implementation to a communication address associated with a CIO party at S440. The CIO data store contains electronic records associated with a plurality of CIO party identifiers, and, for each CIO party identifier, a communication address and at least one CIO parameter.

At S450, the computer server exchanges data with a remote device via a distributed communication network to support interactive user interface displays that include information about the reference implementation. According to some embodiments, the computer also performs security gap identification, security reporting, security trend anticipation, security tool evaluation, etc. The information about the reference implementation is transmitted to a CIO enterprise application team. Moreover, the back-end application computer server may further automatically transmit a security triage alert triggered by an enterprise predictive model (e.g., the security triage alert may be transmitted to the CIO enterprise application team).

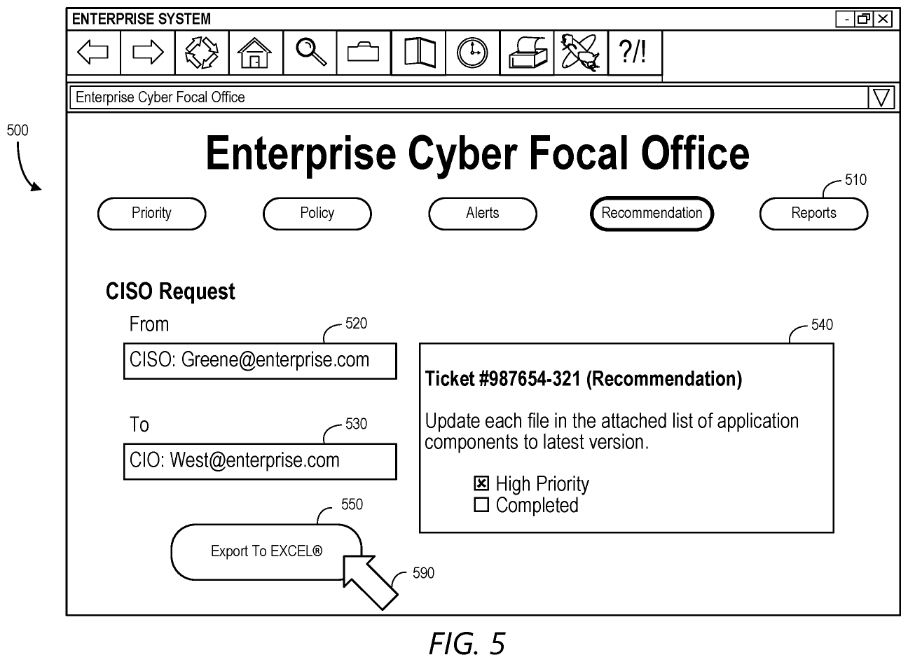

FIG. 5 is an enterprise cyber focal office display 500 in accordance with some embodiments. The display includes several navigation icons 510, including icons selectable via touchscreen or computer mouse pointer 590 to generate a security priority, policy, alert, recommendation, or reports. A CISO request includes a from communication address 520, a to communication address 530, and request details 540. An export icon 550 can be used to output information about the request to an application spreadsheet.

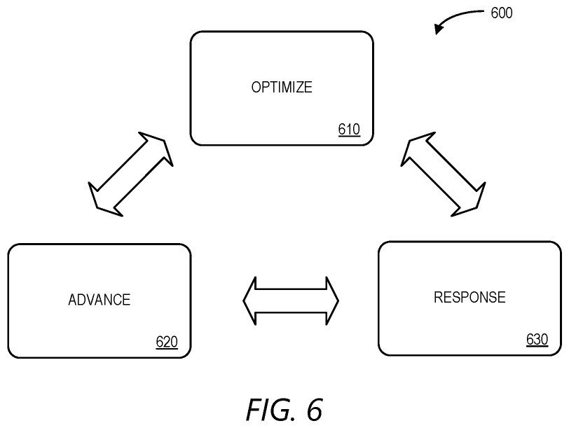

FIG. 6 illustrates cyber focal office interactions 600 according to some embodiments. “Optimize” interactions 610 may automatically identify security gaps, design and/or build reference implementations, promote the adoption of security tools and best practices, coordinate consistent reporting and processes across an enterprise, analyze security practices (and recommend improvements), etc. “Advance” interactions 620 may automatically identify emerging security capabilities, provide, continuous improvement of detection points and dashboards, promote security “shift left” (to implement security measures during an entire development lifecycle instead of only at the end of the cycle), maximize use of existing tools, anticipate security trends, evaluate and build tools, etc. “Respond” interactions 630 may automatically transmit triage application alerts, provide technical support from Level 1 to Level 2 (“L1.5”), Data Incident Response Team (“DIRT”) and Security Incident Response Team (“SIRT”) triage support, widespread vulnerability triage, etc.

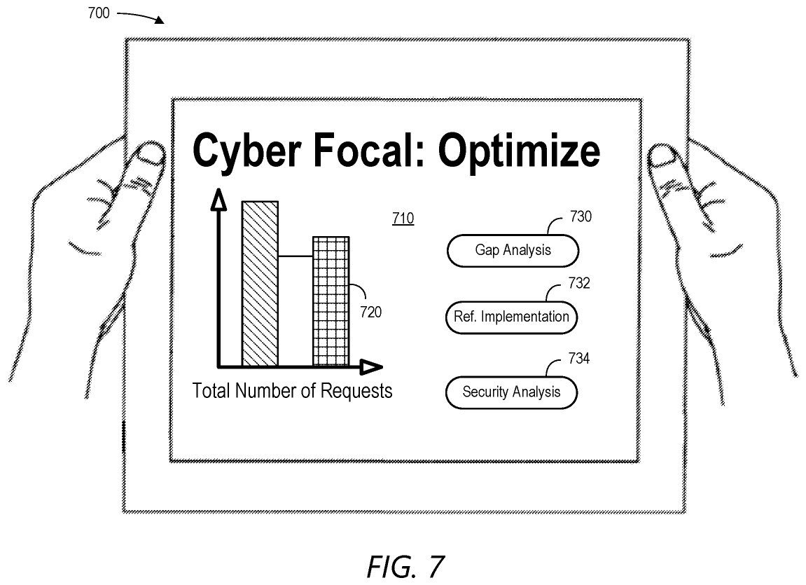

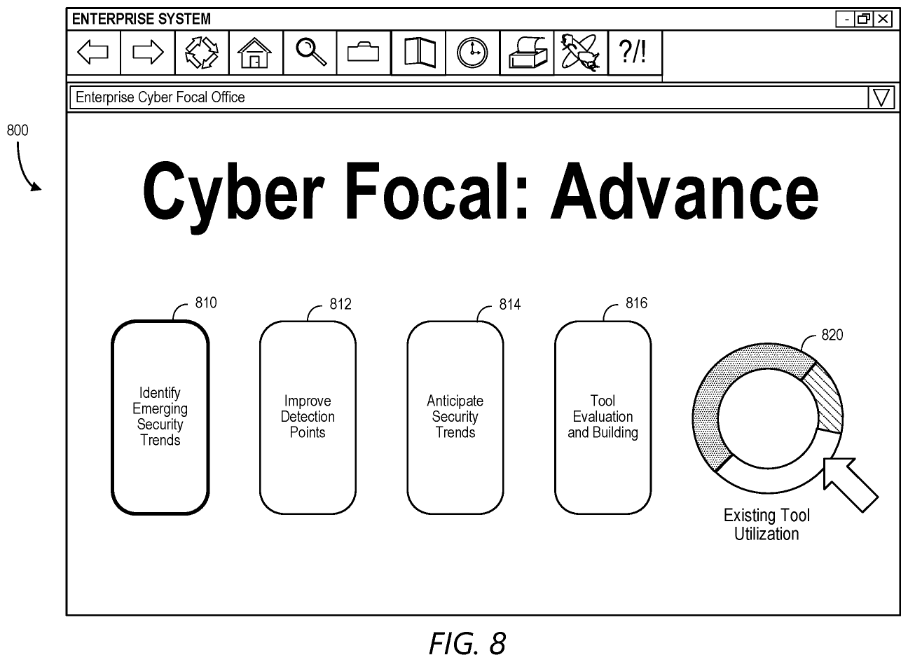

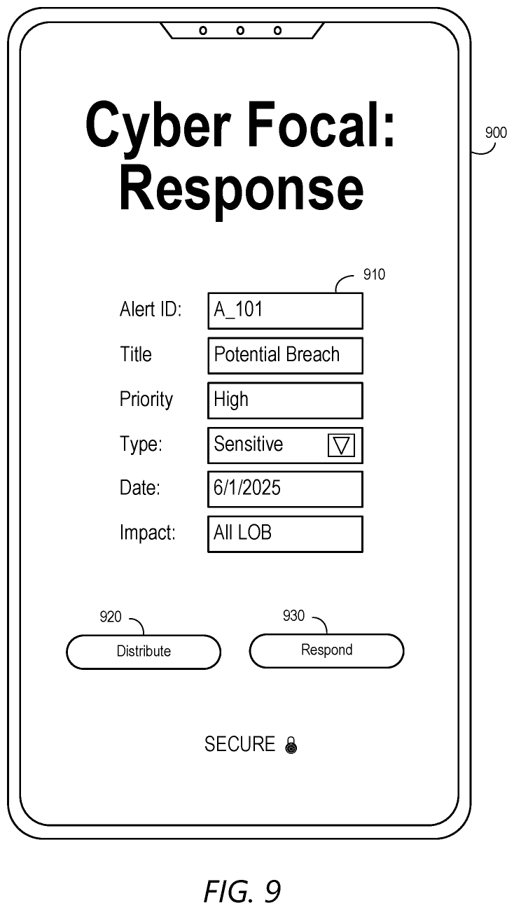

FIG. 7 is a tablet computer 700 providing a cyber focal optimize display 710 in accordance with some embodiments. The display 710 includes a graphical dashboard 720 showing the current overall total number of CISO requests (e.g., pending requests, closed requests, etc.) along with icons to perform a security gap analysis 730, generate a reference implementation 732, execute a security analysis 734, etc. FIG. 8 is a cyber focal advance display 800 according to some embodiments. The display 800 includes icons to identify emerging security trends 810, improve security detection points 812, anticipate security trends 814, perform tool evaluation and building 816, etc. along with a graphical dashboard 820 showing existing security tool utilization (e.g., frequently used, occasionally used, etc.). FIG. 9 is a smartphone 900 providing a cyber focal response display in accordance with some embodiments. The display includes triage alert details 910 (e.g., an alert identifier, title, priority, type, etc.) along with icons to distribute 920 the alert and/or respond 930 to the alert.

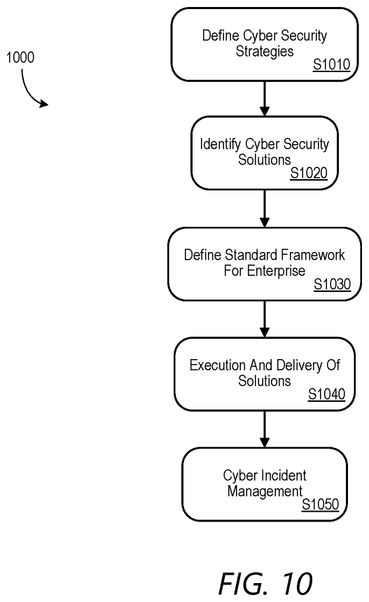

FIG. 10 is a cyber focal office team function method 1000 according to some embodiments. The team may define cyber security strategies for applications at S1010 and identify cyber security solutions (for a common approach enterprise-wide) at S1020. At S1030, the team may define a standard framework for the enterprise so that application teams can take the framework and implement it easily. According to some embodiments, the team may also perform program management of cyber security for the enterprise. At S1040, execution and delivery of cyber security solutions may be performed by the team (e.g., if requested by the CIO). At S1050, the team may perform cyber incident management (to assist in triaging, pattern definition, communication, and solution). Such an approach may serve as a bridge between CISO and CIO teams. The method 1000 may allow for the initial triaging of generic cyber incidents before it reaches application teams (and eliminate duplicate efforts by the LOB and application teams). Moreover, embodiments may vet security solutions before they are rolled out to applications. As a result, any gaps and solution challenges may be addressed upfront. The team may define the framework upfront and avoid any inconsistency across LOB in implementing security solutions. Such an approach may also provide a centralized cyber security strategy to all CIO areas, making it consistent across the enterprise.

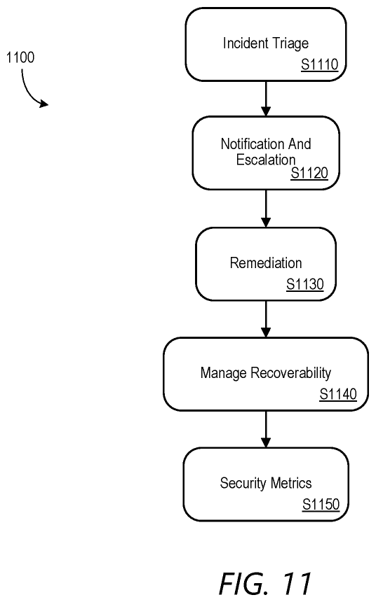

The cyber focal office may be the point of contact for a CIO's application portfolio for all things related to cyber security. The cyber focal office may handle both ingest (new demand from coming from enterprise security teams like zero-day exploit response) and escalation (broadcast of event's detected within their portfolio). The cyber focal office may provide coordination where execution is distributed to application teams that do the actual execution. For example, FIG. 11 is a cyber focal office responsibilities method 1100 in accordance with some embodiments. The cyber focal office may perform application cyber/fraud incident triage and remediation at S110. The cyber focal office may also provide for the timely notification and escalation of security matters to CIO and IT leadership at S1120. At S1130, the cyber focal office may provide oversight of any vulnerabilities that are detected within a portfolio to ensure Service Level Agreement (“SLA”) remediation or approval of exceptions and extensions as appropriate. The cyber focal office may also manage portfolio recoverability including runbooks and testing, provide overall cyber and risk position about a portfolio, and develop and update security metrics for a portfolio at S1150. In some embodiments, the cyber focal office may also manage competing priorities and budgets.

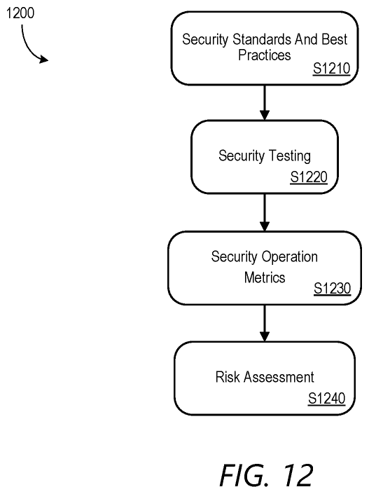

FIG. 12 is a cyber focal office information method 1200 according to some embodiments. At S1210, the cyber focal office ensures that it is informed about security Software Engineer (“SWE”) standards and best practices. The cyber focal office is informed about current security testing practices at S1220 and security operations metrics at S1230. At S1240, the cyber focal office remains informed about a risk assessment status with a portfolio.

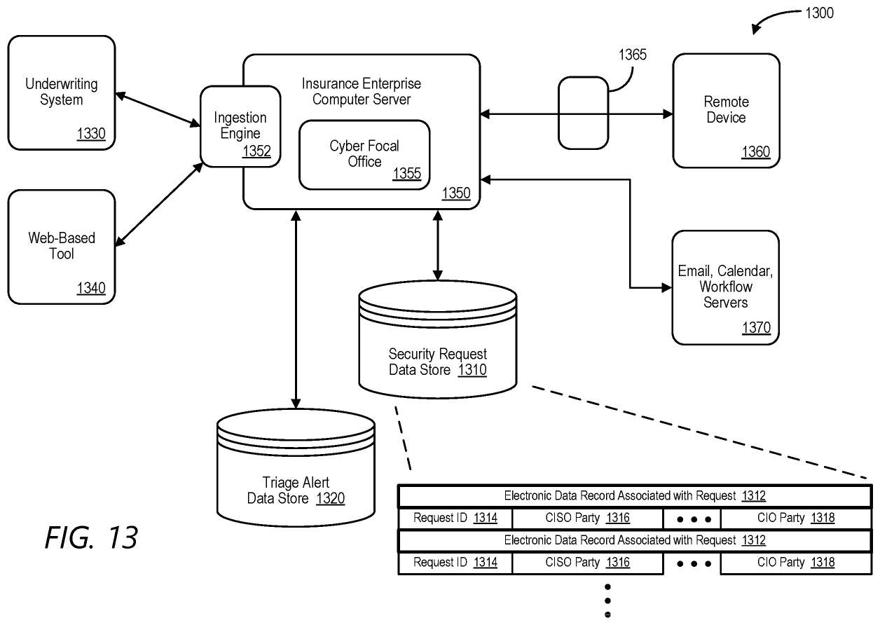

FIG. 13 is a more detailed system 1300 according to some embodiments. As before, the system 1300 includes an insurance enterprise computer server 1350 that may access information in a security request data store 1310 (e.g., storing a set of electronic records associated with CISO requests 1312, each record including, for example, one or more request identifiers 1314, a CISO party 1316, a CIO party 1318, etc.) and triage alert data store 1320. The insurance enterprise computer server 1350 may also exchange information with other data sources, such as an underwriting system 1330 and web-based tool 1340, and utilize an ingestion engine 1352 and cyber focal office 1355 to exchange and process security information and view, analyze, and/or update the electronic records based on information from the underwriting system 1330, the web-based tool 1340, etc. The insurance enterprise computer server 1350 may also exchange information with a remote device 1360 (e.g., via a firewall 1365). According to some embodiments, the back-end application computer server 1350 may interact with an email server (e.g., to automatically establish communication links and/or transmit electronic messages based on risk assessment results), a calendar server (e.g., to automatically schedule tasks or communications based on CISO requests), and/or a workflow server 1370 (e.g., to initiate actions by employees or programs of the enterprise based on an automatic security analysis).

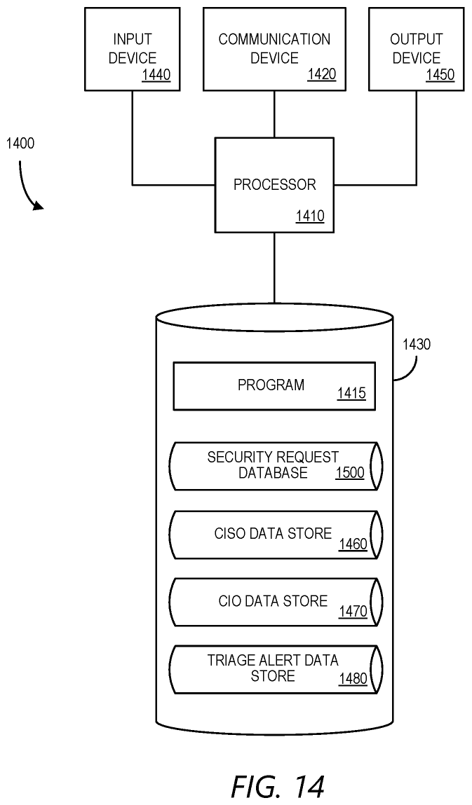

The embodiments described herein may be implemented using any number of different hardware configurations. For example, FIG. 14 illustrates an apparatus 1400 that may be, for example, associated with the systems 3, 13 described with respect to FIGS. 3 and 13, respectively (or any other system described herein). The apparatus 1400 comprises a processor 1410, such as one or more commercially available Central Processing Units (“CPUs”) in the form of one-chip microprocessors, coupled to a communication device 1420 configured to communicate via a communication network (not shown in FIG. 14). The communication device 1420 may be used to communicate, for example, with one or more remote third-party devices, underwriting platforms, web-based tools, administrators, insurance agents, and/or communication devices (e.g., PCs and smartphones). Note that communications exchanged via the communication device 1420 may utilize security features, such as those between a public internet user and an internal network of an insurance company and/or an enterprise. The security features might be associated with, for example, web servers, firewalls, and/or PCI infrastructure. The apparatus 1400 further includes an input device 1440 (e.g., a mouse and/or keyboard to enter information about risk data sources, enterprise cyber security rules or preferences, locations, etc.) and an output device 1450 (e.g., to output reports regarding enterprise cyber security, machine learning algorithms, recommendations, alerts, etc.).

The processor 1410 also communicates with a storage device 1430. The storage device 1430 may comprise any appropriate information storage device, including combinations of magnetic storage devices (e.g., a hard disk drive), optical storage devices, mobile telephones, and/or semiconductor memory devices. The storage device 1430 stores a program 1415 and/or an enterprise cyber security tool or application for controlling the processor 1410. The processor 1410 performs instructions of the program 1415, and thereby operates in accordance with any of the embodiments described herein. For example, the processor 1410 may receive a CISO request. Responsive to the CISO request, the processor 1410 may automatically create an enterprise application reference implementation. Based on CISO parameters in a CISO data store, the processor 1410 may automatically transmit information about the reference implementation to a communication address associated with a CISO party. Similarly, based on CIO parameters in a CIO data store, the processor 1410 may automatically transmit information about the reference implementation to a communication address associated with a CIO party. Data may then be exchanged with a remote device via a distributed communication network to support interactive user interface displays that include information about the reference implementation.

The program 1415 may be stored in a compressed, uncompiled and/or encrypted format. The program 1415 may furthermore include other program elements, such as an operating system, a database management system, and/or device drivers used by the processor 1410 to interface with peripheral devices.

As used herein, information may be “received” by or “transmitted” to, for example: (i) the apparatus 1400 from another device; or (ii) a software application or module within the apparatus 1400 from another software application, module, or any other source.

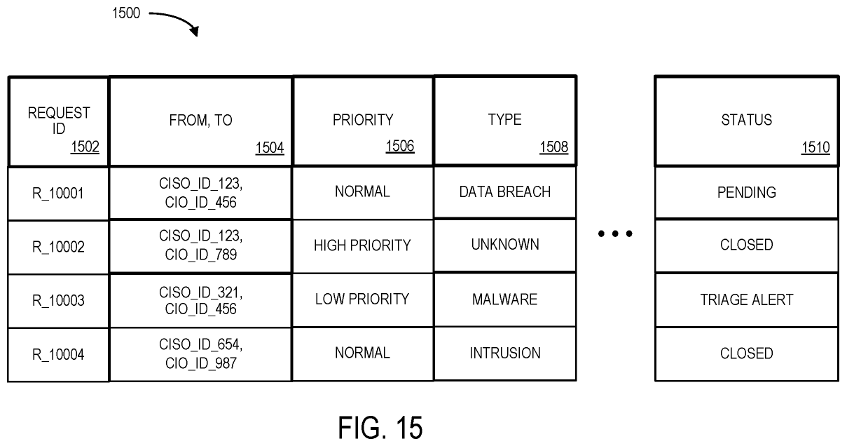

In some embodiments (such as shown in FIG. 14), the storage device 1430 further includes security database 1500, a CISO data store 1460, a CIO data store 1470, and a triage alert data store 1480. An example of a database that might be used in connection with the apparatus 1400 will now be described in detail with respect to FIG. 15. Note that the database described herein is only an example, and additional and/or different information may be stored therein. Moreover, various databases might be split or combined in accordance with any of the embodiments described herein. For example, the CISO data store 1460 and CIO data store 1470 might be combined and/or linked to each other within the program 1415.

Referring to FIG. 15, a table is shown that represents the security request database 1500 that may be stored at the apparatus 1400 according to some embodiments. The table may include, for example, entries associated with different CISO requests that have been provided to a CIO. The table may also define fields 1502, 1504, 1506, 1508, 1510 for each of the entries. The fields 1502, 1504, 1506, 1508, 1510 may, according to some embodiments, specify: a request identifier 1502, from and to identifiers 1504, a priority 1506, a type 1508, and a status 1510. The security request database 1500 may be created and updated, for example, when a new request is created or an existing request is updated in connection with an insurer or business.

The request identifier 1502 may be, for example, a unique alphanumeric code identifying a security request send from a CISO organization to a CIO organization. The from and to identifiers 1504 may, for example, be employee identifiers or communication addresses associated with a party that generated the request and a party that received the request (and/or is responsible for handling the request), respectively. The priority 1506 might indicate if the request is a low priority, normal, or high priority and the type 1508 might describe the nature of the request. The status 1510 might indicate that the request is pending, has been closed, resulted in a triage alert, etc.

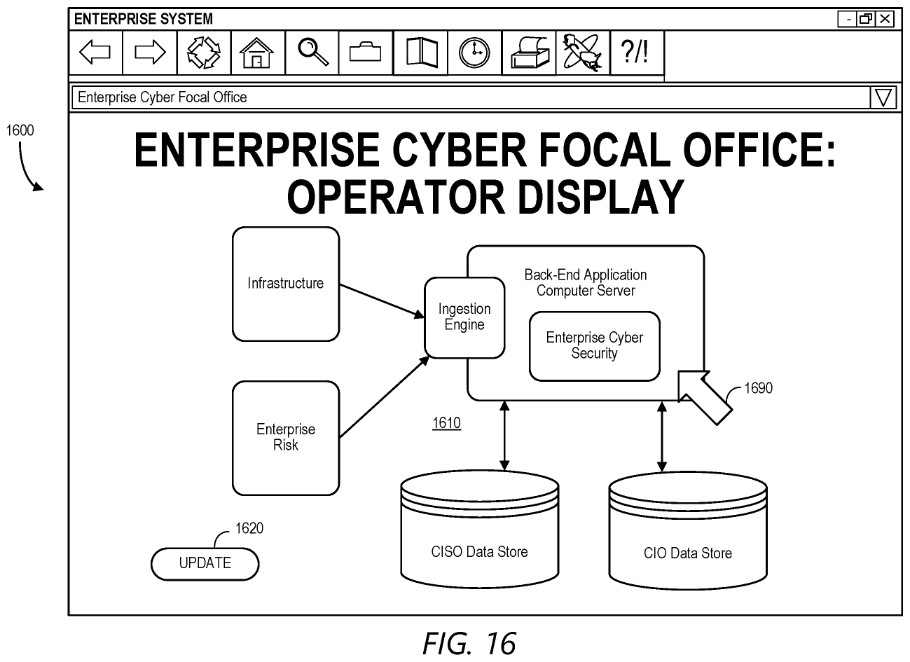

The operation of cyber focal office may be controlled via a Graphical User Interface (“GUI”). For example, FIG. 16 is an enterprise cyber security operator or administrator display 1600 including graphical representations of elements of such a tool 1610 according to some embodiments. Selection of a portion or element of the display 1600 via a touchscreen or pointer 1690 might result in the presentation of additional information about that portion or element (e.g., a popup window presenting data mappings, security request details, etc.) or let an operator or administrator enter or annotate additional information about security information (e.g., based on his or her experience and expertise). An “Update” icon 1620 might initiate an enterprise cyber security process.

Thus, embodiments may provide enterprise cyber security tools to accurately and/or automatically implement enterprise cyber security office tools for an enterprise in a way that provides fast, secure, and useful results and that allows for flexibility and effectiveness when responding to those results. Embodiments may identify solutions and tools (and define frameworks and strategies) for the continuous remediation and enhancements of cyber security. As a result, application teams can easily and quickly implement changes and continuously improve the security of IT applications and assets.

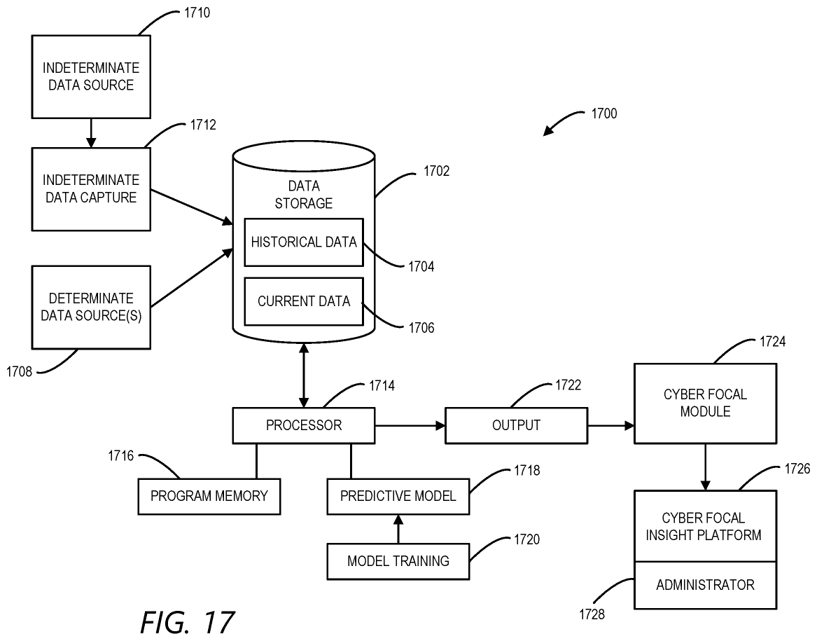

According to some embodiments, one or more artificial intelligence techniques, machine learning algorithms, and/or predictive models may be used to perform a security analysis or prediction, generate an enterprise application reference implementation, etc. Features of some embodiments associated with a predictive model will now be described by referring to FIG. 17. FIG. 17 is a partially functional block diagram that illustrates aspects of a computer system 1700 provided in accordance with some embodiments of the invention. For present purposes it will be assumed that the computer system 1700 is operated by an insurance company (not separately shown) for the purpose of supporting automated security tool functions (e.g., to streamline the collection of and use of security information). According to some embodiments, the third-party data and/or risk data may also be used to supplement and leverage the computer system 1700.

The computer system 1700 includes a data storage module 1702. In terms of its hardware the data storage module 1702 may be conventional, and may be composed, for example, by one or more magnetic hard disk drives. A function performed by the data storage module 1702 in the computer system 1700 is to receive, store and provide access to both historical data 1704 and current data 1706. As described in more detail below, the historical data 1704 is employed to train a predictive model to provide an output that indicates an identified performance metric and/or an algorithm to score or evaluate a security status, and the current data 1706 is thereafter analyzed by the predictive model. Moreover, as time goes by, and results become known from processing current security requests, at least some of the current decisions may be used to perform further training of the predictive model. Consequently, the predictive model may thereby adapt itself to changing conditions.

Either the historical data 1704 or the current data 1706 might include, according to some embodiments, determinate and indeterminate data. As used herein and in the appended claims, “determinate data” refers to verifiable facts such as an application install or update version; a time of day; a day of the week; a geographic location, an address or ZIP code; and a CISO security request or ticket identifier.

As used herein, “indeterminate data” refers to data or other information that is not in a predetermined format and/or location in a data record or data form. Examples of indeterminate data include information from web sites, narrative speech or text, information in descriptive notes fields and signal characteristics in audible voice data files, etc.

The determinate data may come from one or more determinate data sources 1708 that are included in the computer system 1700 and are coupled to the data storage module 1702. The determinate data may include “hard” data like application usage statistics, application response time, etc. One possible source of the determinate data may be an insurance company's database (not separately indicated).

The indeterminate data may originate from one or more indeterminate data sources 1710 and may be extracted from raw files or the like by one or more indeterminate data capture modules 1712. Both the indeterminate data source(s) 1710 and the indeterminate data capture module(s) 1712 may be included in the computer system 1700 and coupled directly or indirectly to the data storage module 1702. Examples of the indeterminate data source(s) 1710 may include data storage facilities for big data streams, document images, text files, and web pages. Examples of the indeterminate data capture module(s) 1712 may include one or more optical character readers, a speech recognition device (i.e., speech-to-text conversion), a computer or computers programmed to perform Natural Language Processing (“NLP”), a computer or computers programmed to identify and extract information from images or video, a computer or computers programmed to detect key words in text files, and a computer or computers programmed to detect indeterminate data regarding request ticket, employee security report, etc.

The computer system 1700 also may include a computer processor 1714. The computer processor 1714 may include one or more conventional microprocessors and may operate to execute programmed instructions to provide functionality as described herein. Among other functions, the computer processor 1714 may store and retrieve historical insurance data 1704 and current data 1706 in and from the data storage module 1702. Thus, the computer processor 1714 may be coupled to the data storage module 1702.

The computer system 1700 may further include a program memory 1716 that is coupled to the computer processor 1714. The program memory 1716 may include one or more fixed storage devices, such as one or more hard disk drives, and one or more volatile storage devices, such as RAM devices. The program memory 1716 may be at least partially integrated with the data storage module 1702. The program memory 1716 may store one or more application programs, an operating system, device drivers, etc., all of which may contain program instruction steps for execution by the computer processor 1714.

The computer system 1700 further includes a predictive model component 1718. In certain practical embodiments of the computer system 1700, the predictive model component 1718 may effectively be implemented via the computer processor 1714, one or more application programs stored in the program memory 1716, and computer stored as a result of training operations based on the historical data 1704 (and possibly also data received from a third party). In some embodiments, data arising from model training may be stored in the data storage module 1702, or in a separate computer store (not separately shown). A function of the predictive model component 1718 may be to determine appropriate performance metric scores, scoring algorithms, reference implementation, security rules, etc. The predictive model component may be directly or indirectly coupled to the data storage module 1702.

The predictive model component 1718 may operate generally in accordance with conventional principles for predictive models, except, as noted herein, for at least some of the types of data to which the predictive model component is applied. Those who are skilled in the art are generally familiar with programming of predictive models. It is within the abilities of those who are skilled in the art, if guided by the teachings of this disclosure, to program a predictive model to operate as described herein.

Still further, the computer system 1700 includes a model training component 1720. The model training component 1720 may be coupled to the computer processor 1714 (directly or indirectly) and may have the function of training the predictive model component 1718 based on the historical data 1704 and/or information about entities. (As will be understood from previous discussion, the model training component 1720 may further train the predictive model component 1718 as further relevant data becomes available.) The model training component 1720 may be embodied at least in part by the computer processor 1714 and one or more application programs stored in the program memory 1716. Thus, the training of the predictive model component 1718 by the model training component 1720 may occur in accordance with program instructions stored in the program memory 1716 and executed by the computer processor 1714.

In addition, the computer system 1700 may include an output device 1722. The output device 1722 may be coupled to the computer processor 1714. A function of the output device 1722 may be to provide an output that is indicative of (as determined by the trained predictive model component 1718) particular security scores, priorities, policies, etc. The output may be generated by the computer processor 1714 in accordance with program instructions stored in the program memory 1716 and executed by the computer processor 1714. More specifically, the output may be generated by the computer processor 1714 in response to applying the data for the current simulation to the trained predictive model component 1718. The output may, for example, be a numerical estimate, a likelihood within a predetermined range of numbers, a summary report, automatically generated triage alerts or security suggestions, prediction of future security trends, etc. In some embodiments, the output device may be implemented by a suitable program or program module executed by the computer processor 1714 in response to operation of the predictive model component 1718.

Still further, the computer system 1700 may include a cyber focal module 1724. The cyber focal module 1724 may be implemented in some embodiments by a software module executed by the computer processor 1714. The cyber focal module 1724 may have the function of rendering a portion of the display on the output device 1722. Thus, the cyber focal module 1724 may be coupled, at least functionally, to the output device 1722. In some embodiments, for example, the cyber focal module 1724 may direct communications with an enterprise by referring to an administrator 1728 via a cyber focal insight platform 1726, messages customized and/or generated by the predictive model component 1718 (e.g., suggesting interaction workflows, alerts or appropriate actions, etc.) and found to be associated with various parties or types of parties. In some embodiments, these results may be provided to the administrator 1728 who may also be tasked with determining whether or not performance may be improved.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to specific types of enterprises, embodiments may instead be associated with other types of businesses in additional to and/or instead of those described herein. Similarly, although certain types of insurance, businesses, and organization parameters were described in connection some embodiments herein, other types of arrangements and configurations might be used instead.

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

What is claimed:

1. An enterprise cyber security system implemented via a back-end application computer server of an enterprise, comprising:
(a) a Chief Information Security Office (“CISO”) data store that contains electronic records associated with a plurality of CISO party identifiers, and, for each CISO party identifier, a communication address and at least one CISO parameter;
(b) a Chief Information Office (“CIO”) data store that contains electronic records associated with a plurality of CIO party identifiers, and, for each CIO party identifier, a communication address and at least one CIO parameter;
(c) the back-end application computer server, coupled to the CISO data store and the CIO data store, including:
a computer processor, and
a computer memory coupled to the computer processor and storing instructions that, when executed by the computer processor, cause the back-end application computer server to:
receive a CISO request,
responsive to the CISO request, automatically create an enterprise application reference implementation,
based on CISO parameters in the CISO data store, automatically transmit information about the reference implementation to a communication address associated with a CISO party, and
based on CIO parameters in the CIO data store, automatically transmit information about the reference implementation to a communication address associated with a CIO party; and
(d) a communication port coupled to the back-end application computer server to facilitate an exchange of data with a remote device via a distributed communication network to support interactive user interface displays that include information about the reference implementation.

2. The system of claim 1, wherein the CISO request is associated with at least one of: (i) a security priority, and (ii) a security policy.

3. The system of claim 1, wherein the back-end application computer server is further to generate the reference implementation based on at least one of: (i) Chief Technology Office (“CTO”) infrastructure information, and (ii) enterprise risk information.

4. The system of claim 1, wherein the back-end application computer server is further to perform at least one of: (i) security gap identification, (ii) security reporting, (iii) security trend anticipation, and (iv) security tool evaluation.

5. The system of claim 1, wherein the information about the reference implementation is transmitted to a CIO enterprise application team.

6. The system of claim 5, wherein the back-end application computer server is further to automatically transmit a security triage alert triggered by an enterprise predictive model.

7. The system of claim 6, wherein the security triage alert is transmitted to the CIO enterprise application team.

8. An enterprise cyber security method implemented via a back-end application computer server of an enterprise, comprising:
receiving, at a back-end application computer server, a Chief Information Security Office (“CISO”) request;
responsive to the CISO request, automatically creating an enterprise application reference implementation;
based on CISO parameters in a CISO data store, automatically transmitting information about the reference implementation to a communication address associated with a CISO party, wherein the CISO data store contains electronic records associated with a plurality of CISO party identifiers, and, for each CISO party identifier, a communication address and at least one CISO parameter;
based on Chief Information Office (“CIO”) parameters in a CIO data store, automatically transmitting information about the reference implementation to a communication address associated with a CIO party, wherein the CIO data store contains electronic records associated with a plurality of CIO party identifiers, and, for each CIO party identifier, a communication address and at least one CIO parameter; and
exchanging data with a remote device via a distributed communication network to support interactive user interface displays that include information about the reference implementation.

9. The method of claim 8, wherein the CISO request is associated with at least one of: (i) a security priority, and (ii) a security policy.

10. The method of claim 8, wherein the back-end application computer server is further to generate the reference implementation based on at least one of: (i) Chief Technology Office (“CTO”) infrastructure information, and (ii) enterprise risk information.

11. The method of claim 8, wherein the back-end application computer server is further to perform at least one of: (i) security gap identification, (ii) security reporting, (iii) security trend anticipation, and (iv) security tool evaluation.

12. The method of claim 8, wherein the information about the reference implementation is transmitted to a CIO enterprise application team.

13. The method of claim 12, wherein the back-end application computer server is further to automatically transmit a security triage alert triggered by an enterprise predictive model.

14. The method of claim 13, wherein the security triage alert is transmitted to the CIO enterprise application team.

15. A non-transitory, computer-readable medium storing instructions, that, when executed by a processor, cause the processor to perform an enterprise cyber security method implemented via a back-end application computer server of an enterprise, the method comprising:
receiving, at a back-end application computer server, a Chief Information Security Office (“CISO”) request;
responsive to the CISO request, automatically creating an enterprise application reference implementation;
based on CISO parameters in a CISO data store, automatically transmitting information about the reference implementation to a communication address associated with a CISO party, wherein the CISO data store contains electronic records associated with a plurality of CISO party identifiers, and, for each CISO party identifier, a communication address and at least one CISO parameter;
based on Chief Information Office (“CIO”) parameters in a CIO data store, automatically transmitting information about the reference implementation to a communication address associated with a CIO party, wherein the CIO data store contains electronic records associated with a plurality of CIO party identifiers, and, for each CIO party identifier, a communication address and at least one CIO parameter; and
exchanging data with a remote device via a distributed communication network to support interactive user interface displays that include information about the reference implementation.

16. The medium of claim 15, wherein the CISO request is associated with at least one of: (i) a security priority, and (ii) a security policy.

17. The medium of claim 15, wherein the back-end application computer service is further to generate the reference implementation based on at least one of: (i) Chief Technology Office (“CTO”) infrastructure information, and (ii) enterprise risk information.

18. The medium of claim 15, wherein the back-end application computer server is further to perform at least one of: (i) security gap identification, (ii) security reporting, (iii) security trend anticipation, and (iv) security tool evaluation.

19. The medium of claim 15, wherein the information about the reference implementation is transmitted to a CIO enterprise application team.

20. The medium of claim 19, wherein the back-end application computer server is further to automatically transmit a security triage alert triggered by an enterprise predictive model.
